(19) United States
(12) Patent Application Publication
(10) Pub. No.: US 2008/0142572 A1
(43) Pub. Date: Jun. 19, 2008

(54) Method of Connecting Metal Material

(75) Inventors: Hidetoshi Fujii, Osaka (JP); Lin Cui, Osaka (JP); Shigeki Matsuoka, Kanagawa (JP); Takeshi Ishikawa, Kanagawa (JP); Kazuo Genchi, Kanagawa (JP)

Correspondence Address: OSHA LIANG L.L.P., 1221 MCKINNEY STREET, SUITE 2800, HOUSTON, TX, 77010, US

(73) Assignees: HIDETOSHI FUJII, OSAKA (JP); TOKYU CAR CORORATION, KANAGAWA (JP)

(21) Appl. No.: 11/579,174

(22) PCT Filed: Mar. 14, 2005
(86) PCT No.: PCT/JP2005/004439

§ 371 Date: Aug. 14, 2007

(30) Foreign Application Priority Data
Apr. 30, 2004 (JP) 2004-136240
Aug. 10, 2004 (JP) 2004-233741
Aug. 13, 2004 (JP) 2004-236146
Nov. 25, 2004 (JP) 2004-341172
Mar. 2, 2005 (JP) 2005-058099

(51) Int. Cl. B23K 20/12

(52) U.S. Cl. 228/114.5

(57) ABSTRACT

A pin formed at front end of a rotary tool 10 made of a metal in a rod shape is inserted between an edge of a metallic member 1 and an edge of a metallic member 1′, which inserted pin is moved along the longitudinal direction of the edges while rotating the pin, thereby generating friction heat between each of the metallic members 1 and 1′ and the rotary tool 10 to weld the metallic member 1 with the metallic member 1′ together. The rotary tool 10 is structured by a wide shoulder 12 and a thin pin 11 formed at the front end of the shoulder 12 and being inserted between the edges of the metallic members. Here, the pin 11 is in a right-cylindrical shape, being formed into smooth curved surface on the side thereof, and having no thread groove thereon.

### TECHNICAL FIELD

The present invention relates to a method for welding metals.

### BACKGROUND ART

There are variations of methods for welding metals. Friction stir welding (FSW) method is one of them, disclosed in Patent Document 1 (Japanese Patent No. 2712838) and Patent Document 2 (Japanese Patent No. 2792233). The friction stir welding method welds two metallic members to be welded by butting each edge thereof, and by inserting a pin formed at front end of a rotary tool in between the butted edges, and then by moving the pin along the longitudinal direction of the edges while rotating the rotary tool.

The pin of the rotary tool used for the friction stir welding method has thread grooves on the side face of the pin. For example, FIGS. 1, 2, 12, and 13 of the Patent Document 1 are merely schematic drawings so that they give no detail of the thread grooves on the pin. Actually, however, as shown in FIG. 2 of Patent Document 2, the thread grooves are formed on the side face of the pin of the rotary tool. The thread grooves are formed aiming to stir the metal which shows plasticity by friction, thus to flow along the longitudinal direction of the pin, thereby improving the welding strength.

### DISCLOSURE OF THE INVENTION

The rotary tool having thread grooves on the pin, however, likely wears the thread peaks, thus that type of rotary tool has a drawback of short life. Particularly when the friction stir welding is applied to metallic members made of hard metals or when the friction stir welding is given over a long welding length, the tendency becomes significant. In addition, the working to form thread grooves on the pin of the rotary tool is troublesome, which leads to high production cost of the rotary tool.

In this regard, the present invention provides a method for welding metals, which improves the life of rotary tool and which lightens the load to troublesome manufacture of rotary tool and reduces the manufacturing cost. In particular, the present invention provides a welding method excellent for welding stainless steels.

The present invention contains the first step of (a) butting two members made of stainless steel at each side edge thereof, and the second step of (b) inserting a pin in a right-cylindrical shape formed at the front end of a rod-shaped rotary tool between the respective side edges of the two members, thereby moving the pin along the longitudinal direction of the edges while rotating the rotary tool, and has a characteristic that (c) the rotary tool with the pin contains Si₃N₄.

According to the present invention, there is formed no thread groove, which is easily worn, on the pin, thus the life of the rotary tool is prolonged. In addition, since there is no need of forming thread groove on the pin, the manufacturing cost of the rotary tool decreases.

The term “right-cylindrical shape” referred to herein signifies a cylindrical shape without thread on the side face of the cylinder, or on the cylinder surface. The “right-cylindrical shape” includes a cylindrical shape having the side face thereof formed by straight line generatrices perpendicular to the bottom face. The pin of the “right-cylindrical shape” includes the one that has R between the bottom face and the side face at top of the pin. The pin in a “right-cylindrical shape” also includes the one in which the bottom face at top of the pin is in R shape.

Note that, the pin of the rotary tool may be a pin having side face formed by straight line generatrices. The term “pin having side face formed by straight line generatrices” signifies a pin having, for example, cylindrical, conical, or truncated cone shape.

### BRIEF DESCRIPTION OF THE DRAWINGS

FIG. 1 illustrates a method for welding metals according to a first embodiment of the present invention.

FIG. 2 illustrates a rotary tool with a pin having a top in a conical shape, used in Experimental Example.

FIG. 3 illustrates a rotary tool with a pin having a top in a spherical shape, used in Experimental Example.

FIG. 4 illustrates a rotary tool with a pin having a top in a polygonal prism shape, used in Experimental Example.

FIG. 5 shows the result of tensile test at the welded part of SUS304 materials, using the rotary tool with a pin having a top in a conical shape.

FIG. 6 shows the result of elongation test at the welded part of SUS304 materials, using the rotary tool with a pin having a top in a conical shape.

FIG. 7 shows the result of tensile test at the welded part of SUS304 materials, using the rotary tool with a pin having a top in a spherical shape.

FIG. 8 shows the result of elongation test at the welded part of SUS304 materials, using the rotary tool with a pin having a top in a spherical shape.

FIG. 9 shows the result of tensile test at welded part of SUS304 materials, using the rotary tool with a pin having a top in a polygonal prism shape.

FIG. 10 shows the result of elongation test at welded part of SUS304 materials, using the rotary tool with a pin having a top in a polygonal prism shape.

FIG. 11 shows the result of tensile test at welded part of SUS301L-DLT materials, using the rotary tool with a pin having a top in a conical shape.

FIG. 12 shows the result of tensile test at welded part of SUS301L-DLT materials, using the rotary tool with a pin having a top in a spherical shape.

FIG. 13 shows the result of elongation test at welded part of SUS301L-DLT materials, using the rotary tool with a pin having a top in a spherical shape.

FIG. 14 shows the result of tensile test at welded part of SUS301L-DLT materials, using the rotary tool with a pin having a top in a polygonal prism shape.

FIG. 15 shows the result of elongation test at welded part of SUS301L-DLT materials, using the rotary tool with a pin having a top in a polygonal prism shape.

FIG. 16 shows the cross sections of welded part in Experimental Example, at various welding speeds, rotational speeds, and rotational pitches.

FIG. 17 shows a comparative table summarizing the results of Experimental Example.

### BEST MODES FOR CARRYING OUT THE INVENTION

The embodiment of the present invention is described below referring to the drawings.

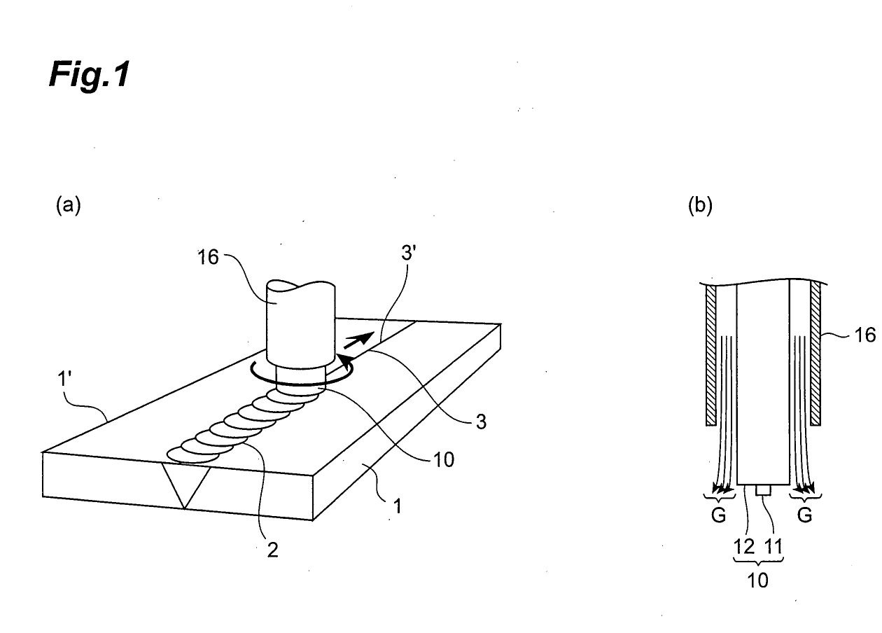

FIG. 1 illustrates the method for welding metals according to the embodiment of the present invention. FIG. 1(a) shows the state of friction stir welding in the method for welding metals according to the embodiment of the present invention. FIG. 1(b) shows a side view of the rotary tool used in the method for welding metals according to the embodiment of the present invention. FIG. 1(b) also shows a cross section of a nozzle.

The method for welding metals relating to the embodiment is the method for welding stainless steels based on the friction stir welding method. As shown in FIG. 1(a), the friction stir welding proceeds by butting an edge part 3 of a metallic member 1 against an edge part 3′ of a metallic member 1′, and by inserting a pin 11 formed at the front end of a rotary tool 10 in a rod shape in between the butted edges 3 and 3′, and then by moving the pin 11 along the longitudinal direction of the edges 3 and 3′ while rotating the pin 11. The friction stir welding welds the metallic member 1 with the metallic member 1′ using the friction heat generated between the rotary tool 10 and each of the metallic members 1 and 1′.

The related art is the friction stir welding method which uses a rotary tool with a pin in a polygonal prism shape or with a pin having thread grooves thereon, made of ceramics or high melting point metal such as W, thus to weld stainless steel materials. To the contrary, the method for welding metals according to the embodiment differs from the conventional friction stir welding method in using the rotary tool 10 shown in FIG. 1(b).

The rotary tool 10 is structured by a wide shoulder 12 and a thin pin 11 which is formed at the front end of the shoulder 12 and which is inserted between the edges of the respective metallic members. The pin 11 is in a right-cylindrical shape. The side face of the pin 11 is in a smooth curved face, and has no thread groove thereon. Here, the shoulder 12 is in a cylindrical shape having larger diameter than that of the pin 11, and extends in the axial direction of the pin 11. The pin 11 is formed at the front end of the shoulder 12, or at an end face of the shoulder 12.

The inventors of the present invention found that also the method for welding metals using the rotary tool with a pin having no thread groove thereon, according to the embodiment, can attain a welding strength at the welded part equal to or higher than that attained in the related art. Here, the term “welded part” referred to herein signifies the part in the vicinity of the welding line on the metallic members after welding.

Since the pin used in the welding method according to the embodiment has no thread groove thereon, there is no fear of wearing the thread peaks. Consequently, the pin life prolongs. Furthermore, since there is no need of forming thread grooves on the pin, the work for manufacturing the rotary tool becomes easy. In addition, the number of steps for manufacturing the rotary tool decreases, thus the rotary tool becomes inexpensive.

A presumable reason for the welding method of the embodiment to attain welding strength equivalent to that attained by the conventional methods is that, without providing the thread groove on the pin, the plastic flow of the metal along the rotational direction of the pin becomes larger than the plastic flow thereof along the longitudinal direction of the pin, which increases the welding strength. The conventional understanding is that the thread grooves on the pin enhance the stirring of metal. Actually, however, a pin in a right-cylindrical shape and having smooth side face such as the pin in the embodiment might rather enhances the stirring of the metal.

The rotary tool 10 shown in FIG. 1(b) preferably contains a binder, other than Si₃N₄. By adding the binder to the rotary tool 10, crack generation on the rotary tool 10 is suppressed. For example, the rotary tool 10 contains Si₃N₄ in an amount of 90% by weight, and balance of Al₂O₃ and Y₂O₃ as the binder. In that case, the hardness (HRA) of the rotary tool 10 is 92 (Rockwell hardness of 120° under a test load of 60 kg by a diamond cone indenter).

Further, as shown in FIG. 1, the welding method of the embodiment preferably uses a nozzle 16 located to cover the side faces of the rotary tool 10 so as to supply a gas G containing Ar from the nozzle 16. The gas containing Ar cools the rotary tool while preventing the hardening of the stainless steel material, and thereby suppressing the crack generation on the rotary tool 10. By welding metallic members while preventing oxidation of the rotary tool using a shield gas such as Ar gas, the welding of long range and long time is attained while maintaining the strength and the toughness of the tool.

The experimental results obtained by the welding method of the embodiment are described below.

### EXPERIMENTAL EXAMPLE

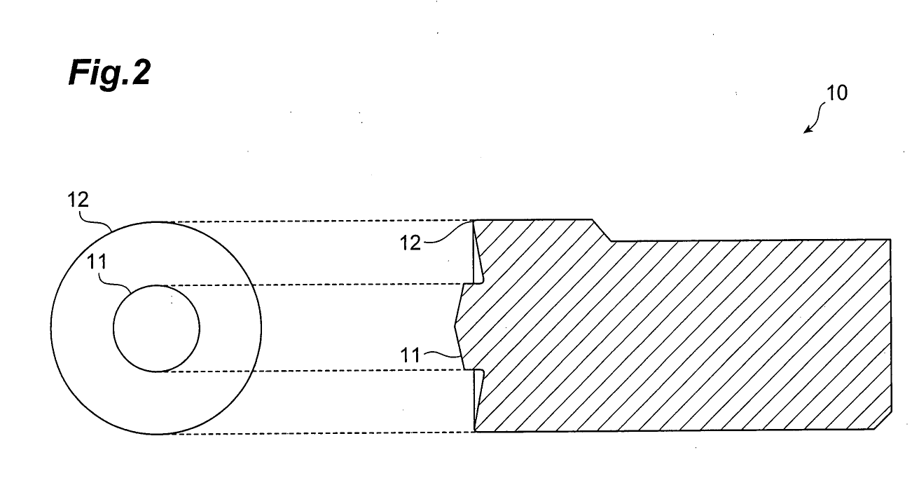

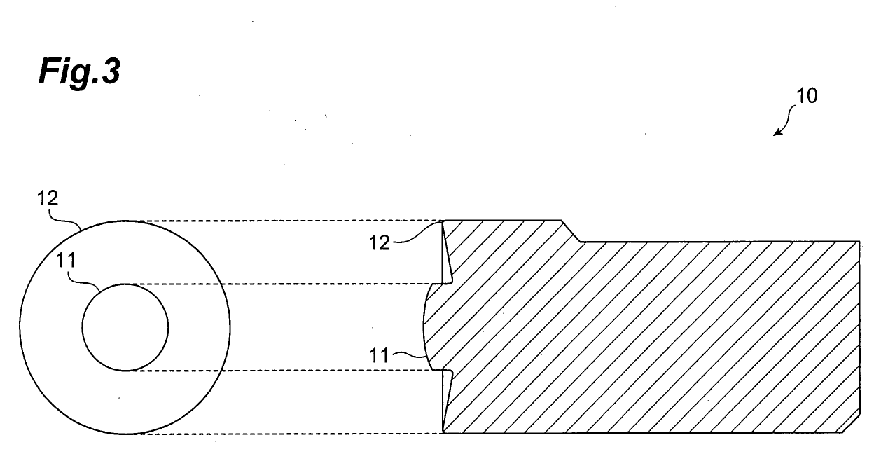

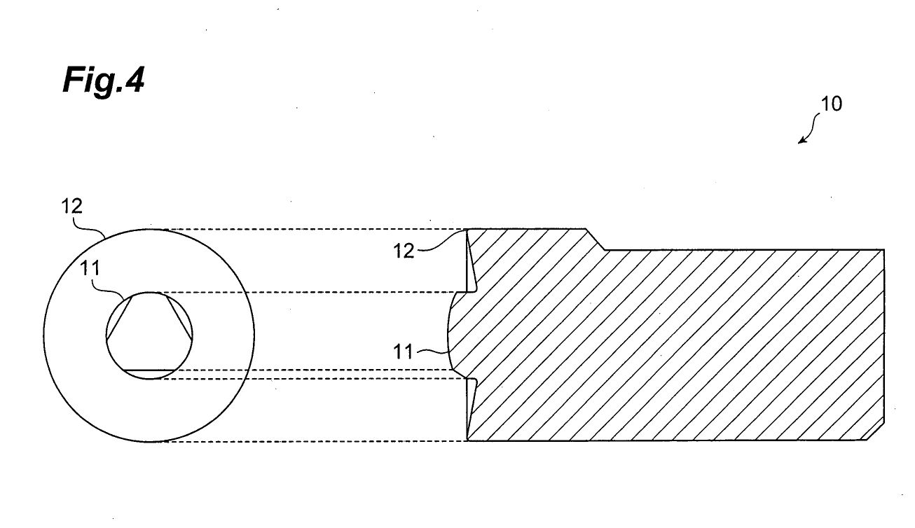

To investigate the relation between the shape of the rotary tool and the welding strength at the welded part of the stainless steels, there was given the welding of SUS304 material specified in JIS G 4305 and SUS301L-DLT material specified by JIS E 4049 using the method illustrated in FIG. 1(a) with a rotary tool with a pin having a top in a conical shape, (refer to FIG. 2), a rotary tool with a pin having a top in a spherical shape, (refer to FIG. 3), and a rotary tool with a pin in a polygonal prism shape, (refer to FIG. 4), respectively. The plate thickness of SUS304 and SUS301L-DLT was 1.5 mm.

The rotary tool 10 shown in FIG. 2 has the pin 11 in a cylindrical shape at the front end thereof. The diameter of the pin 11 is 5 mm, and the diameter of the shoulder 12 is 15 mm. The pin 11 protrudes from the shoulder 12 by 1.4 mm, and a portion of 0.7 mm from the top of the pin 11 is formed in a conical shape as shown in FIG. 2.

The rotary tool 10 shown in FIG. 3 has the pin 11 in a cylindrical shape at the front end thereof. The diameter of the pin 11 is 5 mm, and the diameter of the shoulder 12 is 15 mm. The pin 11 protrudes from the shoulder 12 by 1.4 mm, and the top of the pin 11 is formed in a spherical shape having SR 5.4.

The rotary tool 10 shown in FIG. 4 has the pin 11 in a polygonal prism shape at the front end thereof. The diameter of the pin 11 is 6 mm, and the diameter of the shoulder 12 is 15 mm. The pin 11 protrudes from the shoulder 12 by 1.4 mm. As illustrated in FIG. 4, the pin 11 is C chamfered at three positions on the side face of the cylinder to form approximately polygonal prism shape.

The rotary tools given in FIGS. 2 to 4 have a composition of Si₃N₄ in an amount of 90% and balance of Al₂O₃ and Y₂O₃. In Experimental Example, there were given the tensile test at the welded part and the elongation test thereat using the same sample for each rotary tool.

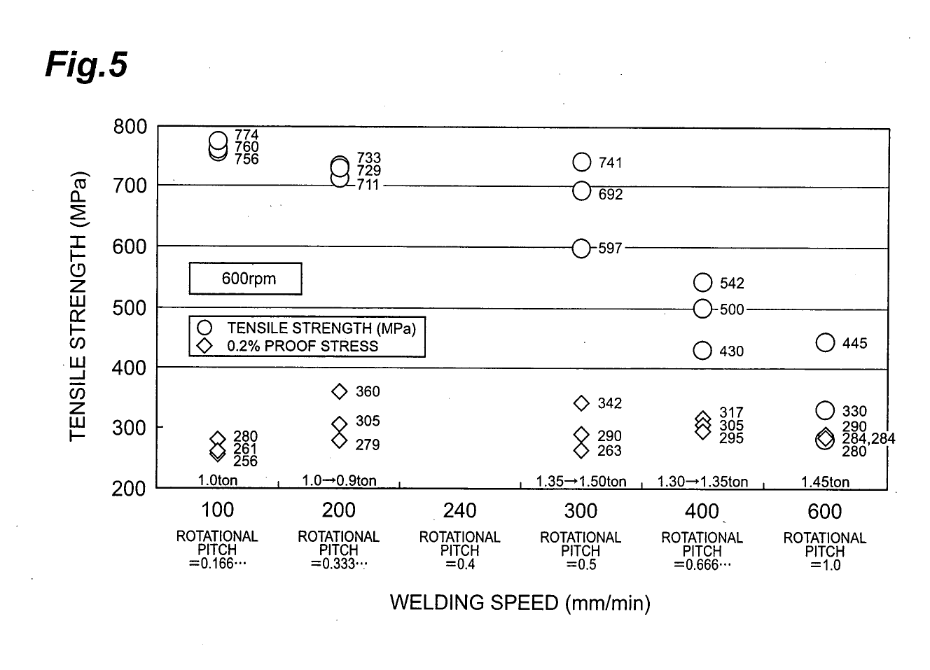

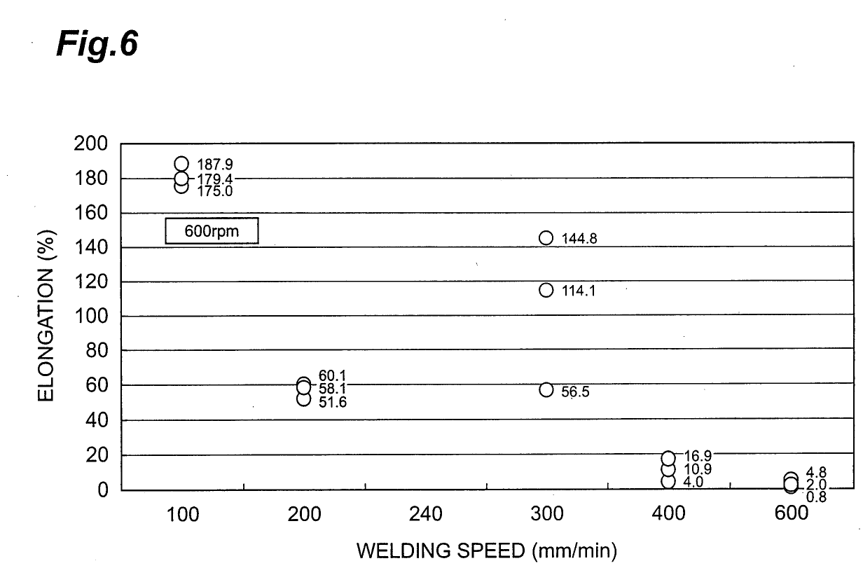

FIG. 5 shows the result of tensile test at the welded part of SUS304 materials welded by the rotary tool with a pin having a top in a conical shape. FIG. 6 shows the result of elongation test at the welded part of SUS304 materials welded by the rotary tool with a pin having a top in a conical shape. In FIGS. 5, 7, 9, 11, 12, and 14, the terms “1.0 ton”, “1.0→0.9 ton”, and the like given on the horizontal axis designate the respective compression forces of the rotary tool against the mother material.

FIG. 5 shows that the welding method of the embodiment gives almost good welding strength at welded part of SUS304 materials under the condition of 300 mm/min or smaller welding speed, 600 rpm of rotational speed, and 0.5 or smaller rotational pitch. As seen in FIG. 6, an adequate value of the elongation was attained at welded part of SUS304 materials under the condition of 300 mm/min or smaller welding speed, 600 rpm of rotational speed, and 0.5 or smaller rotational pitch.

The good welded part of SUS304 materials obtained under the condition of 300 mm/min or smaller welding speed and 0.5 or smaller rotational pitch comes from hardly-generating defects at the welded part. That is, under that welding condition, the heat entering the metallic members (SUS304 materials) is large, and the plastic flow of the metal material is sufficient so that the good welding is attained. It is known that the heat entering a metal is proportional to the rotational speed of the rotary tool and the cube of the shoulder diameter of the rotary tool, while inversely proportional to the welding speed. Considering the known relation, when the SUS304 materials are welded together using a rotary tool with a pin having a top in a conical shape, it is expected to obtain almost good welding strength at the welded part of SUS304 materials if only the value of {(the rotational speed of the rotary tool [rpm]×the shoulder diameter [mm]³)/the moving speed of the rotary tool [mm/min]/the plate thickness [mm]} is 4.5×10³ or larger.

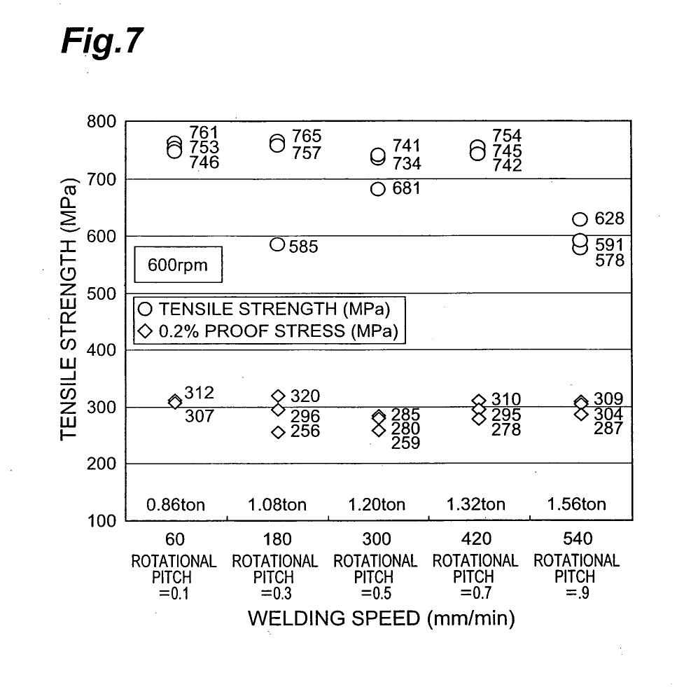

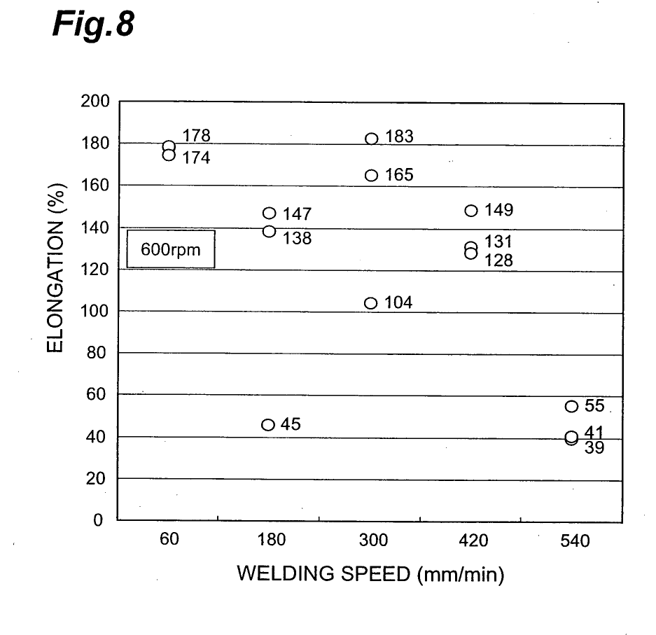

FIG. 7 shows the result of tensile test at the welded part of SUS304 materials, using the rotary tool with a pin having a top in a spherical shape. FIG. 8 shows the result of elongation test at the welded part of SUS304 materials, using the rotary tool with a pin having a top in a spherical shape.

FIG. 7 shows that good welding strength at welded part of SUS304 materials is obtained under the condition of 420 mm/min or smaller welding speed, 600 rpm of rotational speed, and 0.7 or smaller rotational pitch, and specifically at 300 mm/min or smaller welding speed, 600 rpm of rotational speed, and 0.5 or smaller rotational pitch. As seen in FIG. 8, an adequate value of the elongation at welded part of SUS304 materials was obtained under the condition of 300 mm/min or smaller welding speed, 600 rpm of rotational speed, and 0.5 or smaller rotational pitch. From these results, when SUS304 materials are welded together using a rotary tool with a pin having a top in a spherical shape, it is expected to obtain good welding strength at the welded part of SUS304 materials if only the value of {(the rotational speed of the rotary tool [rpm]×the shoulder diameter [mm]³)/the moving speed of the rotary tool [mm/min]/the plate thickness [mm]} is 3.2×10³ or larger.

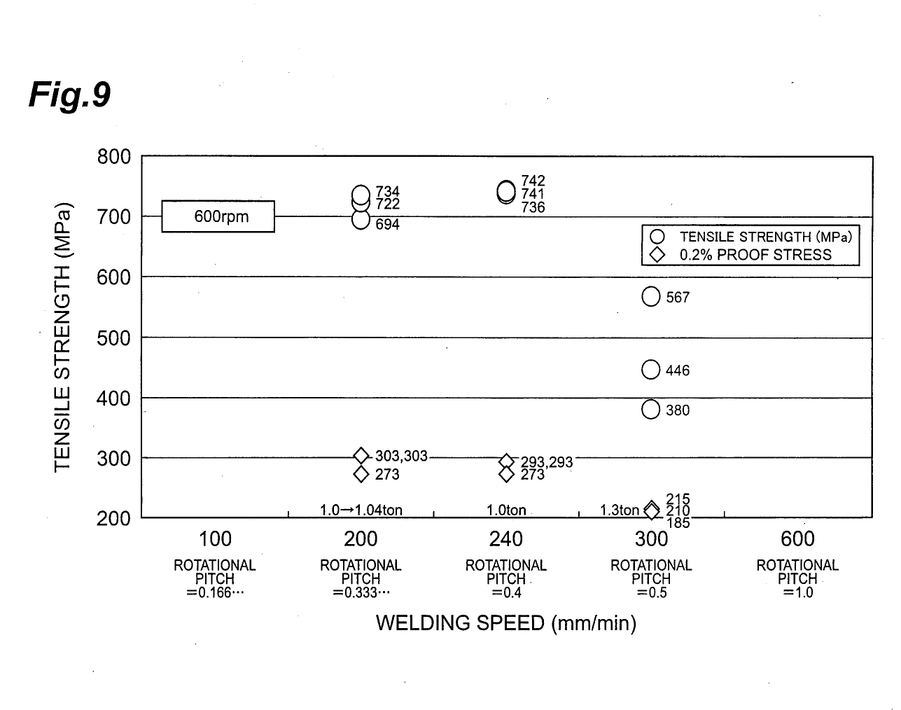

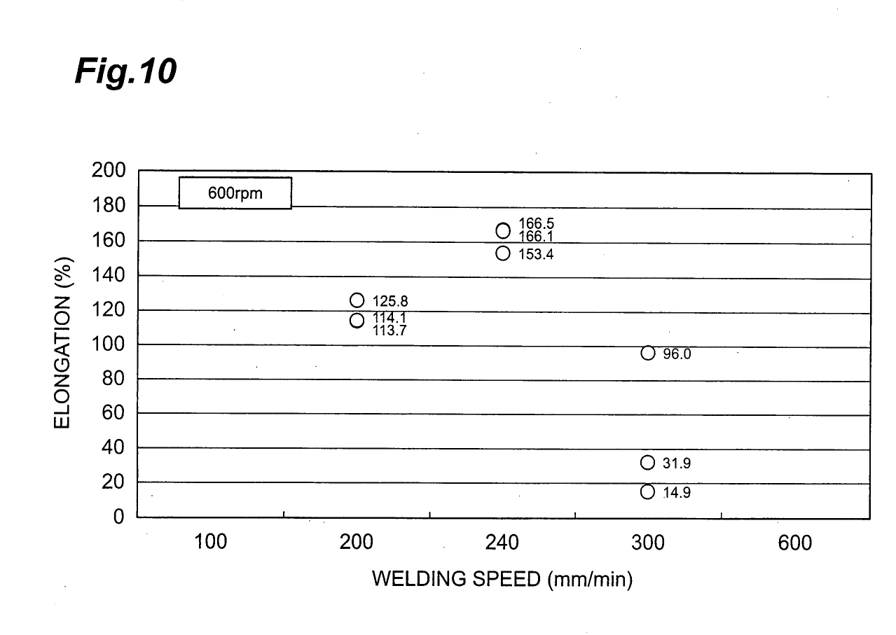

FIG. 9 shows the result of tensile test at the welded part of SUS304 materials, using the rotary tool with a pin in a polygonal prism shape. FIG. 10 shows the result of elongation test at the welded part of SUS304 materials, using the rotary tool with a pin in a polygonal prism shape. FIG. 9 shows that almost good welding strength at welded part of SUS304 materials is obtained under the condition of 300 mm/min or smaller welding speed, 600 rpm of rotational speed, and 0.5 or smaller rotational pitch. As seen in FIG. 10, an adequate value of the elongation at welded part of SUS304 materials was attained under the condition of 300 mm/min or smaller welding speed, 600 rpm of rotational speed, and 0.5 or smaller rotational pitch.

By summarizing the above results, with a rotary tool with a pin having a top in a spherical shape provides almost good welded part of SUS304 materials under the condition of 420 mm/min or smaller welding speed, 0.7 or smaller rotational pitch, and 3.2×10³ or larger value of {(the rotational speed of the rotary tool [rpm]×the shoulder diameter [mm]³)/the moving speed of the rotary tool [mm/min]/the plate thickness [mm]}. Further, with a rotary tool with a pin having a top in a conical shape and with a rotary tool with a pin having a top in a polygonal prism shape provide good welded part of SUS304 materials under the condition of 300 mm/min or smaller welding speed, 0.5 or smaller rotational pitch, and 4.5×10³ or larger value of {(the rotational speed of the rotary tool [rpm]×the shoulder diameter [mm]³)/the moving speed of the rotary tool [mm/min]/the plate thickness [mm]}. Consequently, it was found that the welding method of the embodiment is able to favorably weld SUS304 materials having a thickness of 1.5 mm using a rotary tool having 15 [mm] of shoulder diameter under the condition of 600 [rpm] of rotational speed and 0.1 to 0.7 [mm/r] of rotational pitch. According to the welding method of the embodiment, SUS304 materials are favorably welded together at the value of {(the rotational speed of the rotary tool [rpm]×the shoulder diameter [mm]³)/the moving speed of the rotary tool [mm/min]/the plate thickness [mm]} in a range from 3.233 10³ to 22.5×10³, inclusive. Accordingly, even with a rotary tool with a pin having a top in a conical shape and with a rotary tool with a pin having a top in a spherical shape, better welding strength at the welded part of SUS304 materials is attained than that obtained by the conventional rotary tool with a pin in a polygonal prism shape. In addition, since the pin is not in a polygonal prism shape, the life of rotary tool prolongs, and the manufacture of rotary tool becomes easy.

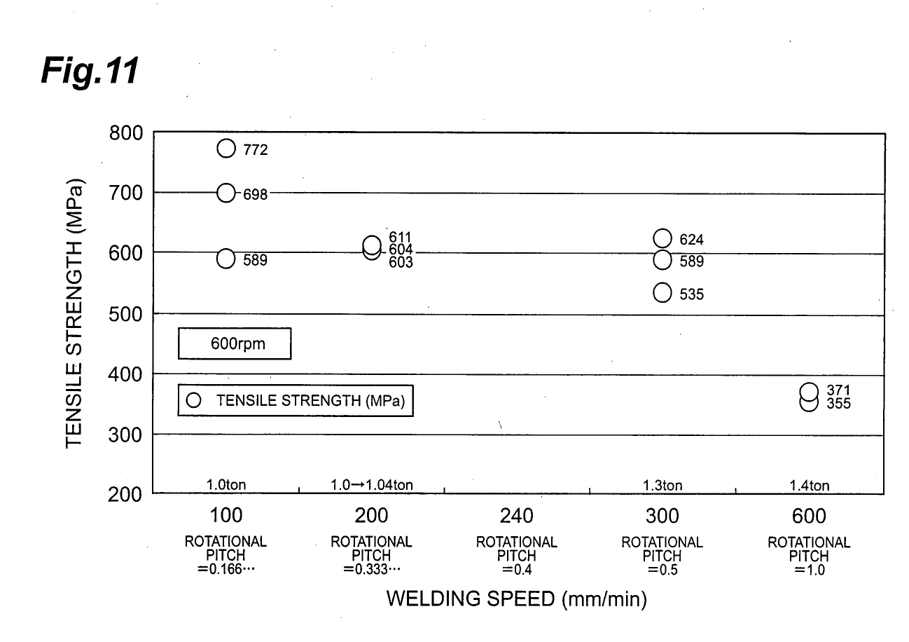

FIG. 11 shows the result of tensile test at the welded part of SUS301L-DLT materials, using the rotary tool with a pin having a top in a conical shape. FIG. 11 shows that almost good welding strength at welded part of SUS301L-DLT materials is obtained under the condition of 300 mm/min or smaller welding speed, 600 rpm of rotational speed, and 0.5 or smaller rotational pitch. The result suggests that a rotary tool with a pin having a top in a conical shape provides almost good welding strength at the welded part of SUS304-DLT materials under the condition of 4.5×10³ or larger value of {(the rotational speed of the rotary tool [rpm]×the shoulder diameter [mm]³)/the moving speed of the rotary tool [mm/min]/the plate thickness [mm]}.

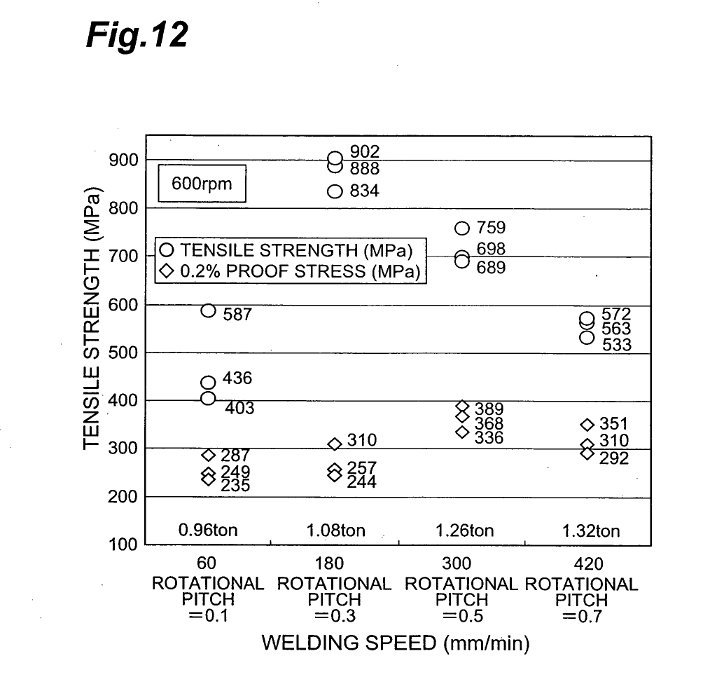

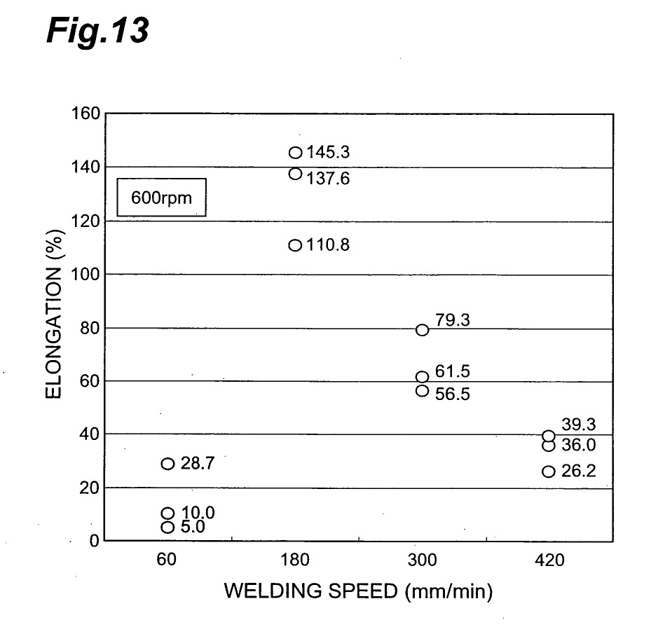

FIG. 12 shows the result of tensile test at the welded part of SUS301L-DLT materials, using the rotary tool with a pin having a top in a spherical shape. FIG. 13 shows the result of elongation test at the welded part of SUS301L-DLT materials, using the rotary tool with a pin having a top in a spherical shape. FIG. 12 shows that almost good welding strength at welded part of SUS301L-DLT materials is obtained under the condition of 180 to 300 mm/min of welding speed, 600 rpm of rotational speed, and 0.3 to 0.5 of rotational pitch. As seen in FIG. 13, also an adequate elongation value at the welded part was obtained under the condition of 180 to 300 mm/min of welding speed, 600 rpm of rotational speed, and 0.3 to 0.5 of rotational pitch. From these results, it is expected that, with a rotary tool with a pin having a top in a spherical shape, almost good welding strength at welded part of SUS301L-DLT materials is obtained under the condition of 4.5×10³ to 7.5×10³ of {(the rotational speed of the rotary tool [rpm]×the shoulder diameter [mm]³)/the moving speed of the rotary tool [mm/min]/the plate thickness [mm]}.

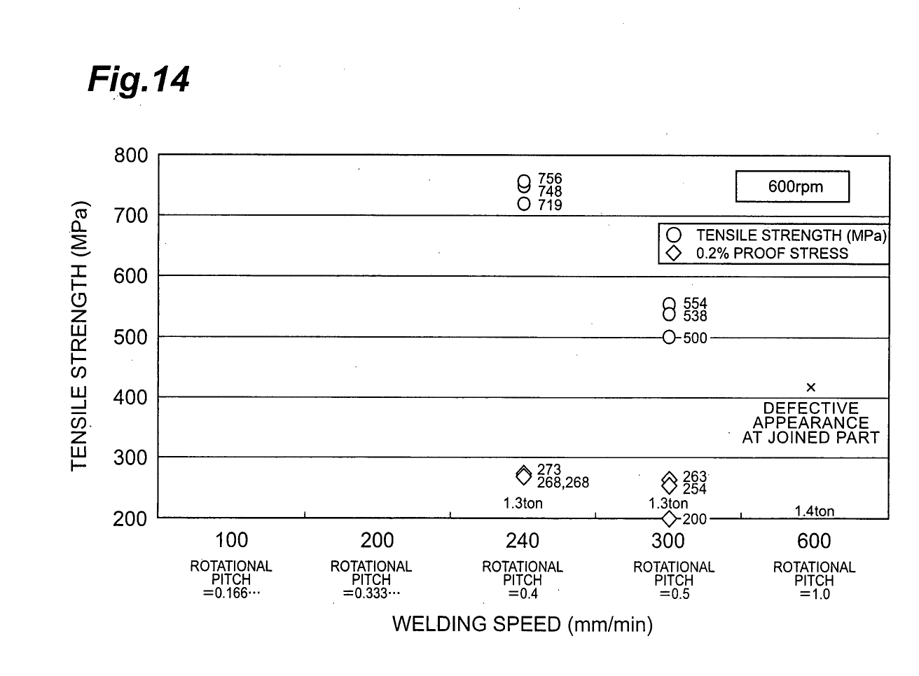

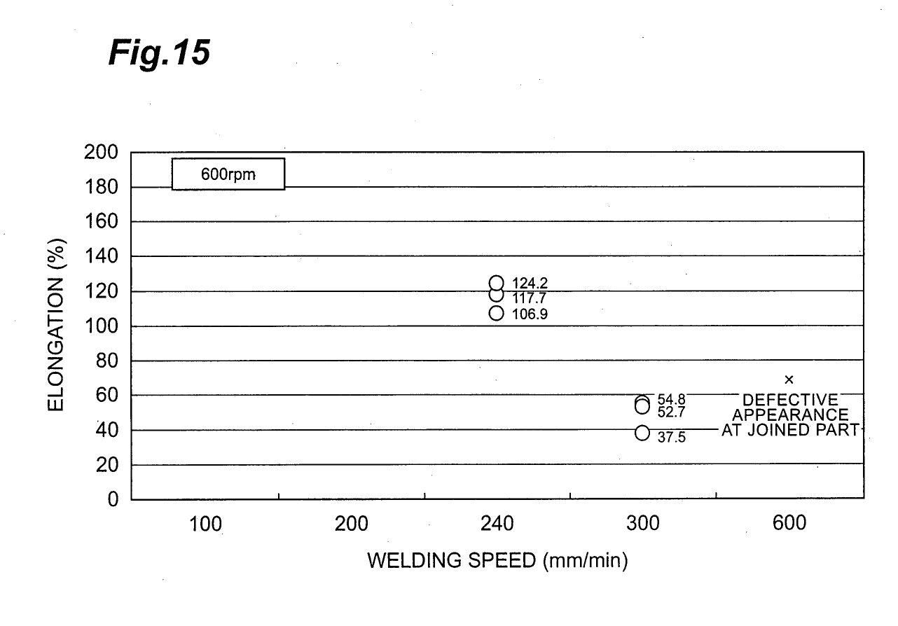

FIG. 14 shows the result of tensile test at the welded part of SUS301L-DLT materials, using the rotary tool with a pin in a polygonal prism shape. FIG. 15 shows the result of elongation test at the welded part of SUS301L-DLT materials, using the rotary tool with a pin in a polygonal prism shape. FIG. 14 shows that almost good welding strength at welded part of SUS301L-DLT materials is obtained under the condition of 300 mm/min or smaller welding speed, 600 rpm of rotational speed, and 0.5 or smaller rotational pitch. As seen in FIG. 15, also an adequate elongation value at the welded part was obtained under the condition of 300 mm/min or smaller welding speed, 600 rpm of rotational speed, and 0.5 or smaller rotational pitch.

By summarizing the above results, with a rotary tool with a pin having a top in a conical shape, with a rotary tool with a pin having a top in a spherical shape, and with a rotary tool with a pin in a polygonal prism shape provide almost good welded part of SUS301L-DLT materials under the condition of 180 to 300 mm/min of welding speed, 0.3 to 0.5 of rotational pitch, and 4.5×10³ to 7.5×10³ of {(the rotational speed of the rotary tool [rpm]×the shoulder diameter [mm]³)/the moving speed of the rotary tool [mm/min]/the plate thickness [mm]}. Accordingly, with a rotary tool with a pin having a top in a conical shape and with a rotary tool with a pin having a top in a spherical shape provide welding strength at the welded part equivalent to that obtained by welding the materials using a conventional rotary tool with a pin in a polygonal prism shape. In addition, since the pin is not in a polygonal prism shape, the life of rotary tool prolongs, and the manufacture of rotary tool becomes easy.

By summarizing the above results, as a tendency of welding in SUS304 materials and SUS304-DLT materials, good welded part is obtained under the condition of, at least, 180 to 300 mm/min of welding speed, 0.3 to 0.5 of rotational pitch, and 4.5×10³ to 7.5×10³ of {(the rotational speed of the rotary tool [rpm]×the shoulder diameter [mm]³)/the moving speed of the rotary tool [mm/min]/the plate thickness [mm]}.

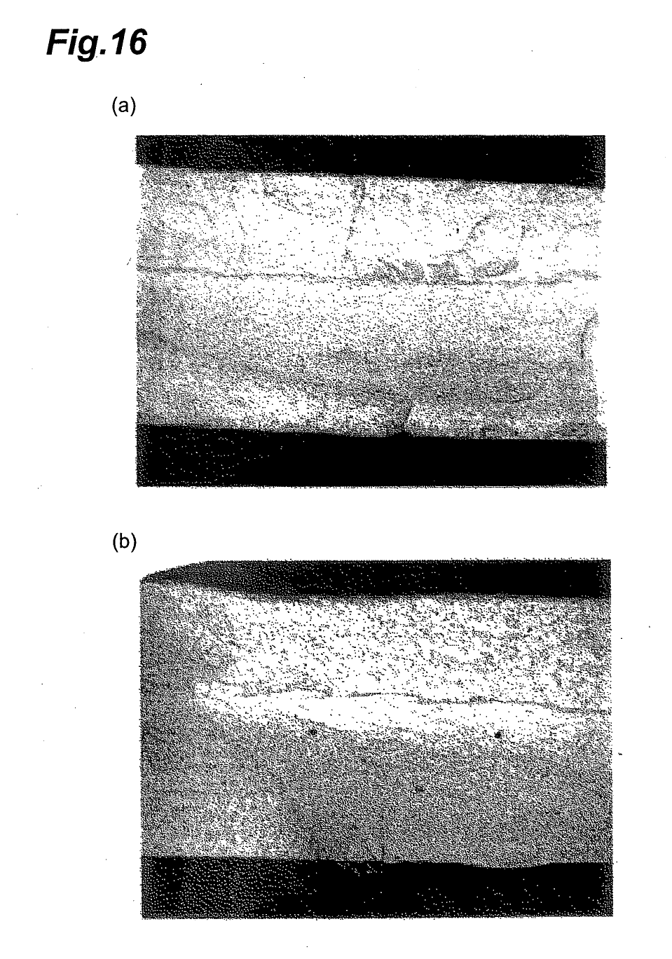

FIGS. 16(a) and 16(b) show the cross sections of welded part in Experimental Example, at different welding speeds, rotational speeds, and rotational pitches. FIG. 16 is the cross sectional photographs of the welded part obtained by a rotary tool with a pin having a top in a conical shape. FIG. 16(a) shows a photograph of cross section obtained under the condition of 600 rpm of rotational speed, 200 mm/min of welding speed, and 0.333 of rotational pitch, while FIG. 16(b) shows a photograph of cross section obtained under the condition of 600 rpm of rotational speed, 300 mm/min of welding speed, and 0.5 of rotational pitch.

As seen in FIG. 16(a), both welded parts generated no defect. Consequently, the good welding strength as shown in above FIG. 5 was obtained presumably caused by the non-defective welded part.

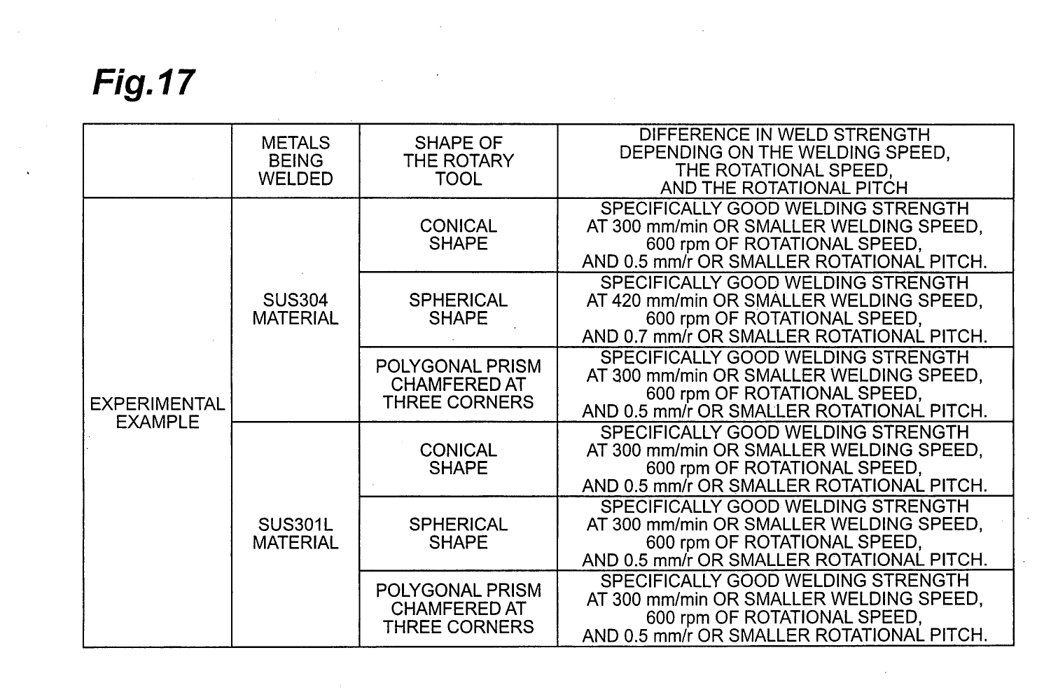

The results of Experimental Example are summarized in FIG. 17 as a comparative table.

It is to be noted that the method for welding metals according to the present invention is not limited to the above embodiment, and can be modified in various ways within the range not departing from the scope of the present invention.

### INDUSTRIAL APPLICABILITY

The present invention provides a method for welding metals which increases the life of rotary tool, and decreases the works for manufacturing the rotary tool and the manufacturing cost thereof.

1. A method for welding metals comprising:
a first step of butting two members made of stainless steel at each side edge thereof; and
a second step of inserting a pin in a right-cylindrical shape formed at a front end of a rotary tool in a rod shape in between the respective side edges of the two members, thereby moving the pin along the longitudinal direction of the edges while rotating the rotary tool; the rotary tool, with the pin, containing Si₃N₄.

2. The method for welding metals according to claim 1, wherein the rotary tool is equipped with a nozzle covering the side face thereof, and the second step supplies a gas containing Ar from the nozzle to the rotary tool and to the members.

3. The method for welding metals according to claim 1, wherein the rotary tool with the pin further contains a binder.

4. The method for welding metals according to claim 2, wherein the rotary tool with the pin further contains a binder.

5. The method for welding metals according to claim 1, wherein the rotary tool has a shoulder in a cylindrical shape having larger diameter than that of the pin, the pin is formed at an end face of the shoulder, each of the two members is a plate of SUS304 specified by JIS G 4305, having a thickness of 1.5 mm, the diameter of the shoulder is 15 mm, the rotational speed of the rotary tool is 600 rpm, and the value of (the moving speed of the rotary tool [mm/min]/the rotational speed of the rotary tool [rpm]) is in a range from 0.1 to 0.7, inclusive.

6. The method for welding metals according claim 2, wherein the rotary tool has a shoulder in a cylindrical shape having larger diameter than that of the pin, the pin is formed at an end face of the shoulder, each of the two members is a plate of SUS304 specified by JIS G 4305, having a thickness of 1.5 mm, the diameter of the shoulder is 15 mm, the rotational speed of the rotary tool is 600 rpm, and the value of (the moving speed of the rotary tool [mm/min]/the rotational speed of the rotary tool [rpm]) is in a range from 0.1 to 0.7, inclusive.

7. The method for welding metals according claim 3, wherein the rotary tool has a shoulder in a cylindrical shape having larger diameter than that of the pin, the pin is formed at an end face of the shoulder, each of the two members is a plate of SUS304 specified by JIS G 4305, having a thickness of 1.5 mm, the diameter of the shoulder is 15 mm, the rotational speed of the rotary tool is 600 rpm, and the value of (the moving speed of the rotary tool [mm/min]/the rotational speed of the rotary tool [rpm]) is in a range from 0.1 to 0.7, inclusive.

8. The method for welding metals according to claim 1, wherein the rotary tool has a shoulder in a cylindrical shape having larger diameter than that of the pin, the pin is formed at an end face of the shoulder, each of the two members is a plate of SUS304 specified by JIS G 4305, and the value of {(the rotational speed of the rotary tool [rpm]×the shoulder diameter [mm]³)/the moving speed of the rotary tool [mm/min]/the plate thickness [mm]} is in a range from 3.2×10³ to 22.5×10³, inclusive.

9. The method for welding metals according to claim 2, wherein the rotary tool has a shoulder in a cylindrical shape having larger diameter than that of the pin, the pin is formed at an end face of the shoulder, each of the two members is a plate of SUS304 specified by JIS G 4305, and the value of {(the rotational speed of the rotary tool [rpm]×the shoulder diameter [mm]³)/the moving speed of the rotary tool [mm/min]/the plate thickness [mm]} is in a range from 3.2×10³ to 22.5×10³, inclusive.

10. The method for welding metals according to claim 3, wherein the rotary tool has a shoulder in a cylindrical shape having larger diameter than that of the pin, the pin is formed at an end face of the shoulder, each of the two members is a plate of SUS304 specified by JIS G 4305, and the value of {(the rotational speed of the rotary tool [rpm]×the shoulder diameter [mm]³)/the moving speed of the rotary tool [mm/min]/the plate thickness [mm]} is in a range from 3.2×10³ to 22.5×10³, inclusive.

11. The method for welding metals according to claims 1, wherein the rotary tool has a shoulder in a cylindrical shape having larger diameter than that of the pin, the pin is formed at an end face of the shoulder, each of the two members is a plate of SUS301L-DLT specified by JIS E 4049, having a thickness of 1.5 mm, the diameter of the shoulder is 15 mm, the rotational speed of the rotary tool is 600 rpm, and the value of (the moving speed of the rotary tool [mm/min]/the rotational speed of the rotary tool [rpm]) is in a range from 0.3 to 0.5, inclusive.

12. The method for welding metals according to claims 2, wherein the rotary tool has a shoulder in a cylindrical shape having larger diameter than that of the pin, the pin is formed at an end face of the shoulder, each of the two members is a plate of SUS301L-DLT specified by JIS E 4049, having a thickness of 1.5 mm, the diameter of the shoulder is 15 mm, the rotational speed of the rotary tool is 600 rpm, and the value of (the moving speed of the rotary tool [mm/min]/the rotational speed of the rotary tool [rpm]) is in a range from 0.3 to 0.5, inclusive.

13. The method for welding metals according to claim 3, wherein the rotary tool has a shoulder in a cylindrical shape having larger diameter than that of the pin, the pin is formed at an end face of the shoulder, each of the two members is a plate of SUS301L-DLT specified by JIS E 4049, having a thickness of 1.5 mm, the diameter of the shoulder is 15 mm, the rotational speed of the rotary tool is 600 rpm, and the value of (the moving speed of the rotary tool [mm/min]/the rotational speed of the rotary tool [rpm]) is in a range from 0.3 to 0.5, inclusive.

14. The method for welding metals according to claim 1, wherein the rotary tool has a shoulder in a cylindrical shape having larger diameter than that of the pin, the pin is formed at an end face of the shoulder, each of the two members is a plate of SUS301L-DLT specified by JIS E 4049, and the value of {(the rotational speed of the rotary tool [rpm]×the shoulder diameter [mm]³)/the moving speed of the rotary tool [mm/min]/the plate thickness [mm]} is in a range from 4.5×10³ to 7.5×10³, inclusive.

15. The method for welding metals according to claim 2, wherein the rotary tool has a shoulder in a cylindrical shape having larger diameter than that of the pin, the pin is formed at an end face of the shoulder, each of the two members is a plate of SUS301L-DLT specified by JIS E 4049, and the value of {(the rotational speed of the rotary tool [rpm]×the shoulder diameter [mm]³)/the moving speed of the rotary tool [mm/min]/the plate thickness [mm]} is in a range from 4.5×10³ to 7.5×10³, inclusive.

16. The method for welding metals according to claim 3, wherein the rotary tool has a shoulder in a cylindrical shape having larger diameter than that of the pin, the pin is formed at an end face of the shoulder, each of the two members is a plate of SUS301L-DLT specified by JIS E 4049, and the value of {(the rotational speed of the rotary tool [rpm]×the shoulder diameter [mm]³)/the moving speed of the rotary tool [mm/min]/the plate thickness [mm]} is in a range from 4.5×10³ to 7.5×10³, inclusive.
